(19) United States
(12) Patent Application Publication
(10) Pub. No.: US 2014/0020463 A1
(43) Pub. Date: Jan. 23, 2014

(54) LIQUID SENSOR

(71) Applicant: AISAN KOGYO KABUSHIKI KAISHA, Aichi-ken (JP)

(72) Inventors: Masaki Ikeya, Aichi-ken (JP); Hideki Asano, Aichi-ken (JP)

(21) Appl. No.: 13/945,333

(22) Filed: Jul. 18, 2013

(30) Foreign Application Priority Data
Jul. 23, 2012 (JP) 2012-163047

(51) Int. Cl. G01F 23/26

(52) U.S. Cl. CPC G01F 23/263
USPC 73/304 C

(57) ABSTRACT

A liquid sensor may comprise a base and a first electrode and a second electrode supported by the base. The first electrode may comprise a plurality of first electrode parts disposed at an interval in a first direction and extending along a second direction being different from the first direction and a second electrode part electrically connecting the plurality of first electrode parts. The second electrode may comprise a plurality of third electrode parts extending along the second direction, the plurality of first electrode parts and the plurality of third electrode parts being disposed alternately in the first direction and a fourth electrode part electrically connecting the plurality of third electrode parts. An opening configured capable of passing the liquid through may be disposed between adjacent first electrode part and third electrode part.

### CROSS-REFERENCE TO RELATED APPLICATION

This application claims priority to Japanese Patent Application No. 2012-163047 filed on Jul. 23, 2012, the contents of which are hereby incorporated by reference into the present application.

### TECHNICAL FIELD

The technique disclosed in the present description relates to a liquid sensor disposed within a reservoir storing liquid.

### DESCRIPTION OF RELATED ART

Japanese Patent Application Publication No. 2005-351689 discloses a liquid level and liquid quality sensor that includes detection electrodes. In this liquid level and liquid quality sensor, the detection electrodes are disposed at an interval on a substrate. The liquid level and liquid quality sensor is used in a state of being immersed in liquid.

### SUMMARY

When the liquid level decreases, parts of the detection electrodes are exposed from the liquid. Capacitance of the detection electrodes changes with an amount of exposure of the detection electrodes (that is, the liquid level). In the configuration of Japanese Patent Application Publication No. 2005-351689, even when the liquid level decreases, a liquid film may be formed on the substrate, and liquid may remain on the substrate. As a result, the capacitance of the detection electrodes may not change appropriately with a decrease in the liquid level. Thus, the present description provides a technique for suppressing a liquid film from being formed on a liquid sensor.

The present application discloses a liquid sensor disposed within a reservoir storing liquid. The liquid sensor may comprise a base, and a first electrode and a second electrode supported by the base. The first electrode may comprise a plurality of first electrode parts disposed at an interval in a first direction and extending along a second direction being different from the first direction, and a second electrode part electrically connecting the plurality of first electrode parts. The second electrode may comprise a plurality of third electrode parts extending along the second direction, where the plurality of first electrode parts and the plurality of third electrode parts are disposed alternately in the first direction, and a fourth electrode part electrically connecting the plurality of third electrode parts. An opening configured capable of passing the liquid through may be disposed between adjacent first electrode part and third electrode part.

According to this configuration, even when the liquid sensor is exposed from the liquid, the opening suppresses a liquid film from being formed on the liquid sensor. As a result, an occurrence of a state in which, even when the liquid level decreases, a part of the liquid sensor is not exposed due to the liquid film may be suppressed.

### BRIEF DESCRIPTION OF DRAWINGS

FIG. 1 schematically shows a sensor system.

FIG. 2 shows a II-II cross section of FIG. 1.

FIG. 3 shows a liquid level sensor according to a second embodiment.

FIG. 4 shows a liquid level sensor according to a third embodiment.

FIG. 5 shows a V-V cross section of FIG. 4.

FIG. 6 shows a diagram for describing a manufacturing method of the level sensor according to the third embodiment.

FIG. 7 shows a liquid level sensor according to a fourth embodiment.

FIG. 8 shows a liquid level sensor according to a fifth embodiment.

FIG. 9 shows a IX-IX cross section of FIG. 8.

FIG. 10 shows an electrode according to the fifth embodiment.

FIG. 11 shows a resin cover covering a liquid level sensor according to a sixth embodiment.

FIG. 12 shows a XII-XII cross section of FIG. 11.

### DETAILED DESCRIPTION

Some of the features of embodiments disclosed herein will be listed.

An opening disposed between adjacent a first electrode part and a third electrode part may extend along a second direction. According to this configuration, a relatively large opening may be provided between first and third electrode parts.

The second direction may be a horizontal direction in a state where a liquid sensor is disposed within a reservoir.

The second direction may be a direction that is inclined with respect to the horizontal direction in the state where the liquid sensor is disposed within the reservoir. According to this configuration, liquid adhering to the liquid sensor may easily flow along the opening. As a result, a liquid film may be suppressed from being formed on the liquid sensor.

The second direction may be a vertical direction in the state where the liquid sensor is disposed within the reservoir. According to this configuration, the liquid adhering to the liquid sensor may easily flow along the opening. As a result, the liquid film may be suppressed from being formed on the liquid sensor.

A base may comprise a thin film-shaped substrate. First and second electrodes may be disposed on a front surface of the base. The opening may be an opening that penetrates the substrate disposed between the adjacent first and third electrode parts from a front surface of the substrate to a rear surface of the substrate. According to this configuration, since the substrate is thin, the liquid may be suppressed from remaining within the opening.

The base may comprise a frame formed of resin. The first and second electrodes may be formed of a metal plate supported by the base. According to this configuration, the first and second electrodes may be easily formed on the base.

The liquid sensor may further comprise a liquid-repellent protective film that covers the first and second electrodes. According to this configuration, the liquid film may be suppressed from being formed on the electrodes.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved liquid sensors, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

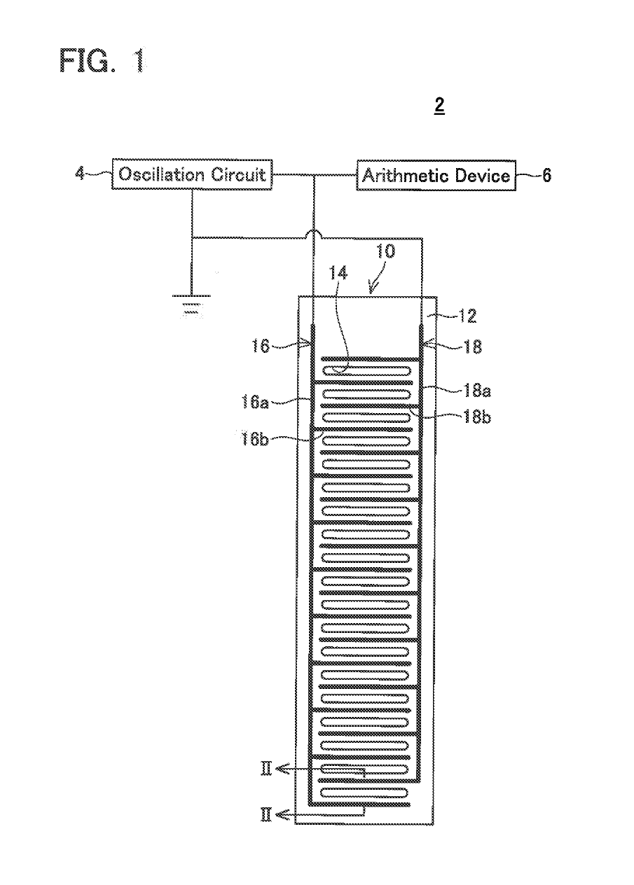

A sensor system 2 shown in FIG. 1 is mounted on a vehicle. The sensor system 2 is used for specifying a liquid level of fuel within a fuel tank. The sensor system 2 includes a liquid level sensor 10, an oscillation circuit 4, and an arithmetic device 6.

The oscillation circuit 4 generates a signal (e.g., AC voltage) of a predetermined cycle (e.g., 10 Hz to 3 MHz). The oscillation circuit 4 is connected to the liquid level sensor 10 with a resistor (not shown) interposed.

The arithmetic device 6 is connected between the oscillation circuit 4 and the liquid level sensor 10. The arithmetic device 6 includes a rectifying unit that rectifies a signal input to the arithmetic device 6, an amplifying unit that amplifies the rectified signal, and a calculating unit that specifies a liquid level of fuel using the amplified signal.

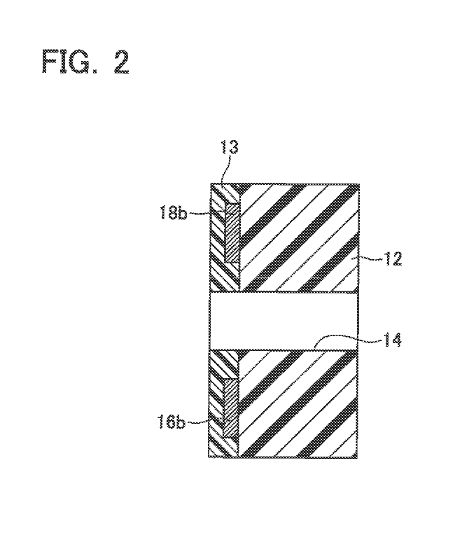

The liquid level sensor 10 includes a substrate 12, two electrodes 16 and 18, and a protective film 13 (see FIG. 2). The protective film 13 is not illustrated in FIG. 1. The substrate 12 is formed in a rectangular form using a resin. The substrate 12 is formed in a thin film form (for example, 0.1 mm to 3 mm). The two electrodes 16 and 18 are disposed on one surface of the substrate 12. The two electrodes 16 and 18 are formed in a thin layer form on the substrate 12 by printing.

The signal electrode 16 is connected to the oscillation circuit 4 with a resistor (not shown) interposed. The signal electrode 16 includes a vertical electrode part 16a and a plurality of (in FIG. 1, ten) horizontal electrode parts 16b (in FIG. 1, only one horizontal electrode part 16b is denoted by reference numeral). The vertical electrode part 16a extends linearly in a longitudinal direction (a depth direction of the fuel tank, hereinafter referred to simply as an “up-down direction”) of the substrate 12.

The vertical electrode part 16a is connected to one set of ends (i.e., the left ends in FIG. 1) of the plurality of horizontal electrode parts 16b. Due to this, the plurality of horizontal electrode parts 16b is electrically connected to the vertical electrode part 16a. The plurality of horizontal electrode parts 16b is parallel to each other, and each extends vertically in the up-down direction. The liquid level sensor 10 is disposed such that the horizontal electrode part 16b is located horizontally in a state where an upper surface of the fuel within the fuel tank is horizontal. The plurality of horizontal electrode parts 16b is disposed at an equal interval in the up-down direction. The plurality of horizontal electrode parts 16b has the same length. The length of the horizontal electrode parts 16b is determined such that the horizontal electrode parts 16b are separated by a predetermined distance from a vertical electrode part 18a of the reference electrode 18.

The reference electrode 18 is disposed on the right side of the signal electrode 16. The reference electrode 18 is grounded. The reference electrode 18 includes the vertical electrode part 18a and a plurality of (in FIG. 1, ten) horizontal electrode parts 18b (in FIG. 1, only one horizontal electrode part 18b is denoted by reference numeral). The vertical electrode part 18a extends linearly in the up-down direction. That is, the vertical electrode part 18a is disposed in parallel to the vertical electrode part 16a.

The vertical electrode part 18a is connected to one set of ends (i.e., the right ends in FIG. 1) of the plurality of horizontal electrode parts 18b. Due to this, the plurality of horizontal electrode parts 18b is electrically connected to the vertical electrode part 18a. The plurality of horizontal electrode parts 18b is parallel to each other, and each extends vertically in the up-down direction. The plurality of horizontal electrode parts 18b is disposed at an equal interval in the up-down direction. The horizontal electrode parts 18b and 16b are alternately disposed at an interval when seen from an upper end to a lower end of the substrate 11 The plurality of horizontal electrode parts 18b has the same length as the horizontal electrode parts 16b. The length of the horizontal electrode parts 18b is determined such that the horizontal electrode parts 18b are separated by a predetermined distance from the vertical electrode part 16a.

The substrate 12 includes a through-hole 14 disposed in the gap between the horizontal electrode parts 16b and 18b. The through-hole 14 is disposed in each gap between the adjacent horizontal electrode parts 16b and 18b. That is, the substrate 12 includes a plurality of (in FIG. 1, nineteen) through-holes 14 (in FIG. 1, only one through-hole 14 is denoted by reference numeral). The horizontal electrode parts 18b, the through-holes 14, and the horizontal electrode parts lob are disposed at an interval in that order when seen from the upper end to the lower end of the substrate 12. The through-holes 14 extend in parallel to the horizontal electrode parts 16b and 18b (i.e., the through-holes 14 extend vertically in the up-down direction). The through-holes 14 penetrate the substrate 12 from one surface of the substrate 12 to the other surface. That is, fuel can pass through the through-holes 14. In a modification, a through-hole 14 may be disposed at least in one of gaps between the horizontal electrode parts 16b and 18b.

As shown in FIG. 2, a protective film 13 is formed on the front surface of the substrate 12. The protective film 13 is formed of a material (oil-repellent material) that repels fuel that uses fluorine as its raw material. The protective film 13 covers the front surface of the substrate 12 and the surfaces of the electrodes 16 and 18.

Next, a utilization method of the liquid level sensor 10 will be described. In a state where the liquid level sensor 10 is disposed within the fuel tank, the signal of a predetermined cycle is supplied from the oscillation circuit 4 to the signal electrode 16. The arithmetic device 6 specifies the capacitance of the electrodes 16 and 18 (i.e., the liquid level sensor 10) associated with the liquid level of the fuel within the fuel tank of the present time (i.e., the time When the liquid level is detected using the liquid level sensor 10). The arithmetic device 6 specifies the liquid level of the fuel from the specified capacitance using a database stored in advance in the arithmetic device 6.

In the liquid level sensor 10, the through-hole 14 is formed in the substrate 12. Thus, it is possible to suppress a liquid film of the fuel from being formed at a portion of the liquid level sensor 10 that is to be exposed from the fuel after the liquid level of the fuel decreases. As a result, it is possible to suppress the occurrence of a state in which a part of the liquid level sensor 10 is not exposed due to the liquid film despite the decrease of the liquid level. As a result, it is possible to suppress a capacitance of the liquid level sensor 10 from becoming a value that is not associated with the actual liquid level. Further, the protective film 13 can more appropriately suppress the liquid film from being formed on the surfaces of the electrodes 16 and 18 and the substrate 12.

In addition, at the portion of the liquid level sensor 10 immersed in the fuel, the fuel is filled within the through-holes 14. On the other hand, at the portion of the liquid level sensor 10 exposed from the fuel, no fuel is filled within the through-holes 14. The capacitance between the horizontal electrode parts 16b and 18b changes depending on whether fuel is present in the interposed through-hole 14. As a result, in the liquid level sensor 10, it is possible to increase an amount of change in the capacitance of the liquid level sensor 10 to the liquid level of the fuel as compared to a liquid level sensor in which the through-hole 14 is not formed. According to this configuration, it is possible to more accurately specify the liquid level of the fuel using the liquid level sensor 10.

Further, since the substrate 12 is formed in a thin film form, it is possible to make fuel difficult to remain in the through-holes 14. Since the thin layer-shaped electrodes 16 and 18 are formed on the thin film-shaped substrate 12, the liquid level sensor 10 has small surface unevenness and foreign materials are suppressed from being caught on the surface.

### Second Embodiment

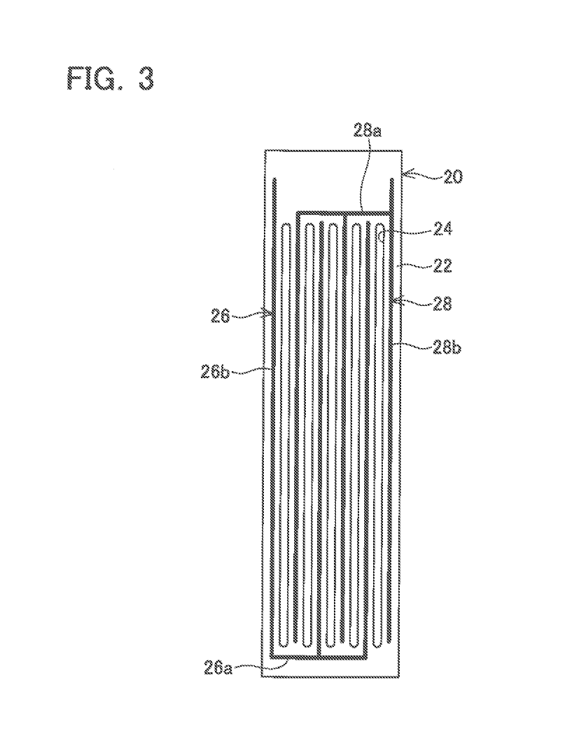

As shown in FIG. 3, in a second embodiment, a sensor system 2 includes a liquid level sensor 20 instead of the liquid level sensor 10. The other configuration is the same as the first embodiment.

The liquid level sensor 20 includes a substrate 22, two electrodes 26 and 28, and a protective film (not shown). The substrate 22 is formed in a rectangular thin film form using a resin similarly to the substrate 12. The two electrodes 26 and 28 are disposed on one surface of the substrate 22 similarly to the electrode 16 and the like.

The signal electrode 26 is connected to the oscillation circuit 4 with a resistor (not shown) interposed. The signal electrode 26 a horizontal electrode part 26a and a plurality of (in FIG. 3, three) vertical electrode parts 26b (in FIG. 3, only one vertical electrode part 26b is denoted by reference numeral). The horizontal electrode part 26a extends linearly in a lateral direction (i.e., a direction vertical to the up-down direction) of the substrate 22.

The horizontal electrode part 26a is connected to one set of ends (i.e., the lower ends in FIG. 3) of the plurality of vertical electrode parts 26b. Due to this, the plurality of vertical electrode parts 26b is electrically connected to the horizontal electrode part 26a. The plurality of vertical electrode parts 26b is parallel to each other, and each extends in the up-down direction. The liquid level sensor 20 is disposed so that the vertical electrode part 26b is located vertically to the upper surface of the fuel in a state where the upper surface of the fuel within the fuel tank is horizontal. The plurality of vertical electrode parts 26b is disposed at an equal interval in a direction vertical to the up-down direction. The length of the vertical electrode part 26b is determined such that the vertical electrode part 26b is separated by a predetermined distance from a horizontal electrode part 28a of the reference electrode 28.

The reference electrode 28 is disposed above the signal electrode 26. The reference electrode 28 is grounded. The reference electrode 28 includes the horizontal electrode part 28a and a plurality of (in FIG. 3, three) vertical electrode parts 28b (in FIG. 3, only one vertical electrode part 28b is denoted by reference numeral). The horizontal electrode part 28a extends linearly in a direction vertical to the up-down direction. That is, the horizontal electrode part 28a is disposed in parallel to the horizontal electrode part 26a.

The horizontal electrode part 28a is connected to one set of ends (i.e., the upper ends in FIG. 3) of the plurality of vertical electrode parts 28b. Due to this, the plurality of vertical electrode parts 28b is electrically connected to the horizontal electrode part 28a. The plurality of vertical electrode parts 28b is parallel to each other, and each extends in the up-down direction. The plurality of vertical electrode parts 28b is disposed at an equal interval in a direction vertical to the up-down direction. The vertical electrode parts 26b and 28b are alternately disposed at an interval when the substrate 22 is seen in a direction vertical to the up-down direction. The plurality of vertical electrode parts 28b has the same length as the vertical electrode parts 26b. The length of the vertical electrode part 28b is determined such that the vertical electrode part 28b is separated by a predetermined distance from the horizontal electrode part 26a.

The substrate 22 includes a through-hole 24 disposed in each gap between the vertical electrode parts 26b and 28b. The through-hole 24 is disposed in all gaps between the adjacent vertical electrode parts 26b and 28b. That is, the substrate 22 includes a plurality of (in FIG. 3, five) through-holes 24 (in FIG. 3, only one through-hole 24 is denoted by reference numeral). The vertical electrode part 26b, the through-hole 24, and the vertical electrode part 28b are disposed at an interval in that order when the substrate 22 is seen in a direction vertical to the up-down direction from the left end of FIG. 3. The through-hole 24 extends in parallel to the vertical electrode parts 26b and 28b (i.e., the through-hole 24 extends in the up-down direction). The through-holes 24 penetrate the substrate 22 from one surface of the substrate 22 to the other surface similarly to the through-holes 14 so that fuel can pass through the through-holes 24. In a modification, the through-hole 24 may be disposed in at least one of the gaps between the vertical electrode parts 26b and 28b.

The liquid level sensor 20 of the second embodiment can provide the same advantages as the liquid level sensor 10. Moreover, since the through-holes 24 extend in the up-down direction, the fuel adhering to the liquid level sensor 20 can easily flow along the through-holes 24. As a result, it is possible to suppress a liquid film from being formed on the liquid level sensor 20.

### Third Embodiment

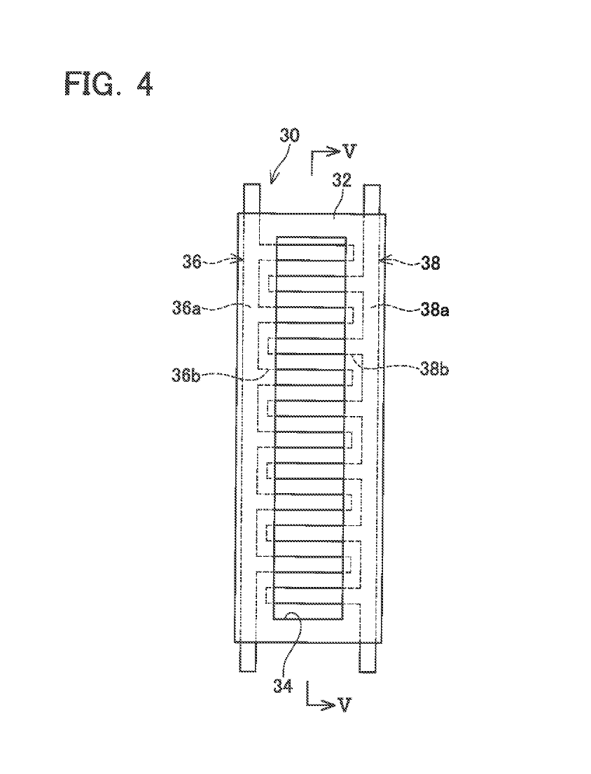

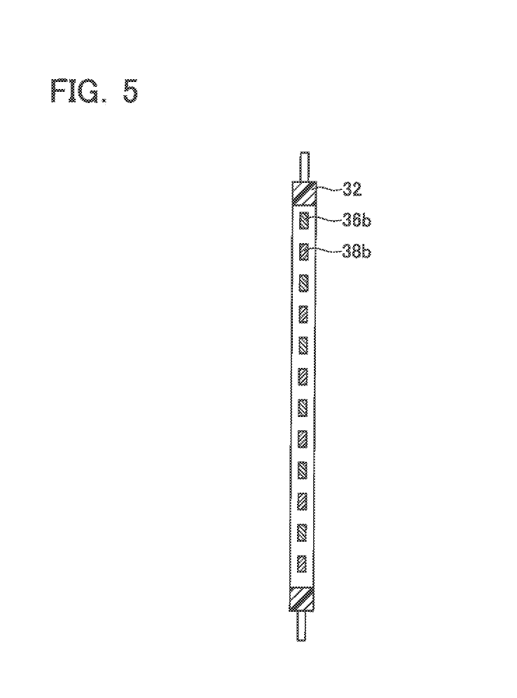

As shown in FIG. 4, in a third embodiment, a sensor system 2 may include a liquid level sensor 30 instead of the liquid level sensor 10. The other configuration is the same as the first embodiment.

The liquid level sensor 30 includes a frame 32 and two electrodes 36 and 38. The frame 32 is formed of a resin. The frame 32 is a frame that has a rectangular opening 34 formed therein. The frame 32 surrounds the outer edge of the opening 34 in a rectangular form.

The signal electrode 36 is connected to the oscillation circuit 4 with a resistor (not shown) interposed. The signal electrode 36 includes a vertical electrode part 36a and a plurality of (in FIG. 4, six) horizontal electrode parts 36b (in FIG. 4, only one horizontal electrode part 36b is denoted by reference numeral). The vertical electrode part 36a extends linearly in a longitudinal direction (i.e., a depth direction of the fuel tank, hereinafter referred simply to as an “up-down direction”) of the flame 32. The vertical electrode part 36a is covered by the frame 32 excluding the upper and lower ends.

The vertical electrode part 36a is connected to one set of ends (i.e., the left ends in FIG. 4) of the plurality of horizontal electrode parts 36b. Due to this, the plurality of horizontal electrode parts 36b is electrically connected to the vertical electrode part 36a. The plurality of horizontal electrode parts 36b is parallel to each other, and each extends vertically in the up-down direction. The liquid level sensor 30 is disposed so that the horizontal electrode parts 36b are located horizontally in a state where an upper surface of the fuel within the fuel tank is horizontal. The plurality of horizontal electrode parts 36b is disposed at an equal interval in the up-down direction. The plurality of horizontal electrode parts 36b has the same length. The length of the horizontal electrode parts 36b is determined such that the horizontal electrode parts 36b are separated by a predetermined distance from a vertical electrode part 38a of the reference electrode 38. Both ends in a direction vertical to the up-down direction of the horizontal electrode parts 36b are covered by the frame 32. Due to this, the frame 32 can strongly support both ends of the horizontal electrode parts 36b.

The reference electrode 38 is disposed on the right side of the signal electrode 36. The reference electrode 38 is grounded. The reference electrode 38 includes the vertical electrode part 38a and a plurality of (in FIG. 4, six) horizontal electrode parts 38b (in FIG. 4, only one horizontal electrode part 38b is denoted by reference numeral). The vertical electrode part 38a extends linearly in the up-down direction. That is, the vertical electrode part 38a is disposed in parallel to the vertical electrode part 36a. The vertical electrode part 38a is covered by the frame 32 excluding the upper and lower ends.

The vertical electrode part 38a is connected to one set of ends (the right ends in FIG. 4) of the plurality of horizontal electrode parts 38b. Due to this, the plurality of horizontal electrode parts 38b is electrically connected to the vertical electrode part 38a. The plurality of horizontal. electrode parts 38b is parallel to each other, and each extends vertically in the up-down direction. The plurality of horizontal electrode parts 38b is disposed at an equal interval in the up-down direction. The horizontal electrode parts 38b and 36b are alternately disposed at an interval when seen from the upper end to the lower end of the frame 32. The plurality of horizontal electrode parts 38b has the same length as the horizontal electrode parts 36b. The length of the horizontal electrode parts 38b is determined such that the horizontal electrode parts 38b are separated by a predetermined distance from the vertical electrode part 36a. Both ends in a direction vertical to the up-down direction of the horizontal electrode parts 38b are covered by the frame 32. Due to this, the frame 32 can support both ends of the horizontal electrode parts 38b.

Since the horizontal electrode parts 36b and 38b are disposed at an interval, the opening 34 penetrates in between the horizontal electrode parts 36b and 38b. The opening 34 extends in parallel along the horizontal electrode parts 36b and 38b. As shown in FIG, 5, the opening 34 penetrating between the horizontal electrode parts 36b and 38b allows fuel to pass from one side of the frame 32 to the other side. In other words, part of the opening 34 is blocked by the horizontal electrode parts 36b and 38b, and the opening 34 is thereby divided.

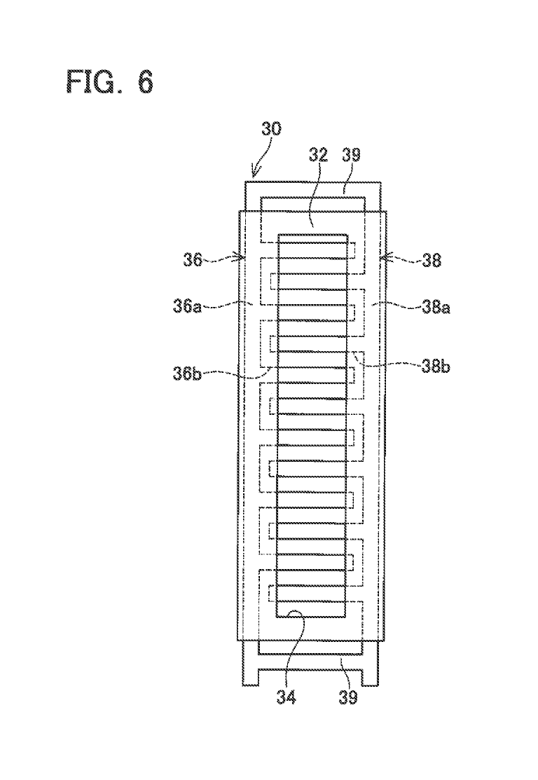

As shown in FIG. 6, the electrodes 36 and 38 are formed by pressing a flat plate made from metal (for example, SUS). The pressed electrodes 36 and 38 are connected by a cut part 39 disposed at the upper and lower ends. That is, the electrodes 36 and 38 are formed to be integrated. The integrated electrodes 36 and 38 are fixed to the frame 32 by so-called insert molding which involves disposing the electrodes in a molding die when the frame 32 is resin-molded. When the frame 32 is molded, the cut part 39 is cut out. In this manner, the electrodes 36 and 38 are electrically isolated. The electrodes 36 and 38 are integrated by the cut part 39 until the frame 32 is molded. Due to this, the electrodes 36 and 38 can be easily disposed within the molding die. Moreover, it is not necessary to perform positioning of the electrodes 36 and 38 when the electrodes 36 and 38 are disposed in the molding die. According to this configuration, it is possible to easily dispose the electrodes 36 and 38 in the frame 32.

In the liquid level sensor 30, similarly to the liquid level sensor 10, it is possible to suppress the occurrence of a state in which part of the liquid level sensor 30 is not exposed due to the liquid film. As a result, it is possible to suppress a capacitance of the liquid level sensor 30 from becoming a value that is not associated with the actual liquid level.

Moreover, the opening 34 allows the fuel to pass between the horizontal electrode parts 36b and 38b. As a result, since fuel is filled in the space between the horizontal electrode parts 36b and 38b in the portion of the liquid level sensor 30 immersed in the fuel, it is possible to increase an amount of change in the capacitance of the liquid level sensor 30 to the liquid level of the fuel.

### Fourth Embodiment

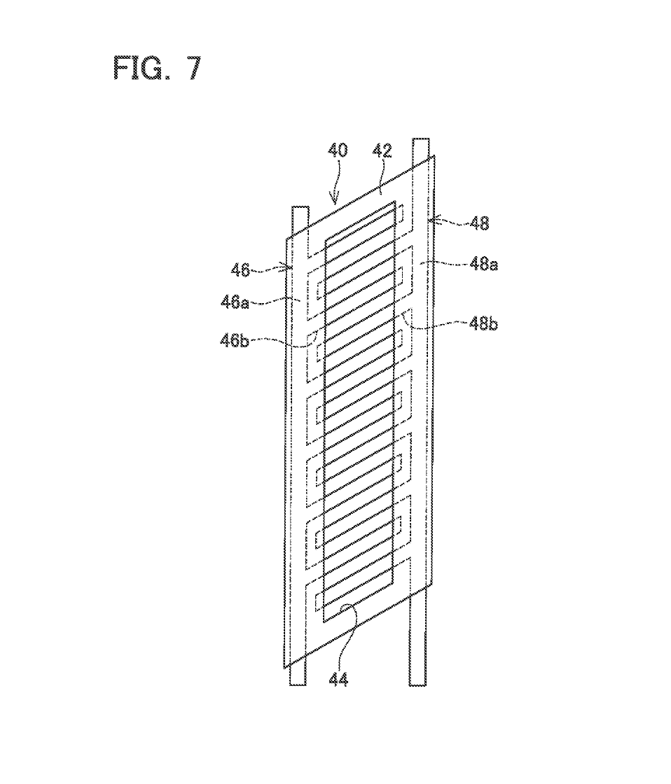

In the liquid level sensor 30 of the third embodiment, the horizontal electrode parts 36b and 38b of the electrodes 36 and 38 are disposed vertically in the up-down direction. However, as shown in FIG. 7, in a liquid level sensor 40 of a fourth embodiment, horizontal electrode parts 46b and 48b of electrodes 46 and 48 are inclined from a direction (that is, a horizontal direction) vertical to the up-down direction. Specifically, the horizontal electrode parts are inclined upward as they advance from the left end of FIG. 7 toward the right end. Vertical electrode parts 46a and 48a have the same configuration as the vertical electrode parts 36a and 38a. That is, the horizontal electrode parts 46b are inclined from a direction vertical to the vertical electrode part 46a, and the horizontal electrode parts 48b are inclined from a direction vertical to the vertical electrode part 48a.

An opening 44 passes through a frame 42 at the position between the vertical electrode parts 46a and 48a and extends in parallel along the vertical electrode parts 46a and 48a. Between the vertical electrode parts 46a and 48a, the opening 44 is disposed in parallel to the vertical electrode parts 46a and 48a. The upper and lower ends of the frame 42 are disposed in parallel to the horizontal electrode parts 46b and 48b.

The liquid level sensor 40 provides the same advantages as the liquid level sensor 30. Moreover, since the opening 44 is inclined from the horizontal direction, liquid adhering to the liquid level sensor 40 can easily flow along the horizontal electrode parts 46b and 48b. As a result, it is possible to suppress a liquid film from being formed on the liquid level sensor 40.

### Fifth Embodiment

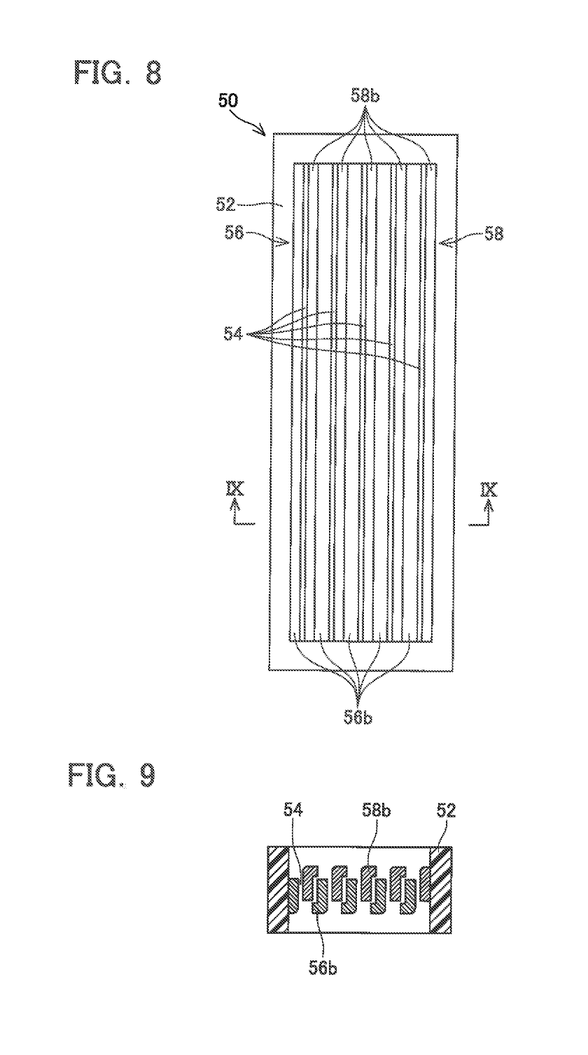

As shown in FIG. 8, a sensor system 2 includes a liquid level sensor 50 instead of the liquid level sensor 10. The other configuration is the same as the first embodiment.

The liquid level sensor 50 includes a frame 52 and two electrodes 56 and 58. The frame 52 is formed of a resin. The frame 52 is a frame that has rectangular openings 54 formed therein. The frame 52 surrounds the outer edge of the openings 54.

The signal electrode 56 is connected to the oscillation circuit 4 with a resistor (not shown) interposed. The signal. electrode 56 includes a frame electrode part 56a (see FIG. 10) and a plurality of (in FIG. 8, five) vertical electrode parts 56b. As shown in FIG. 10, the frame electrode part 56a includes two side frame members extending in the up-down direction and two side frame members extending in a direction vertical to the up-down direction and forms a rectangular frame. The frame electrode part 56a is covered by the frame 52 over an entire length.

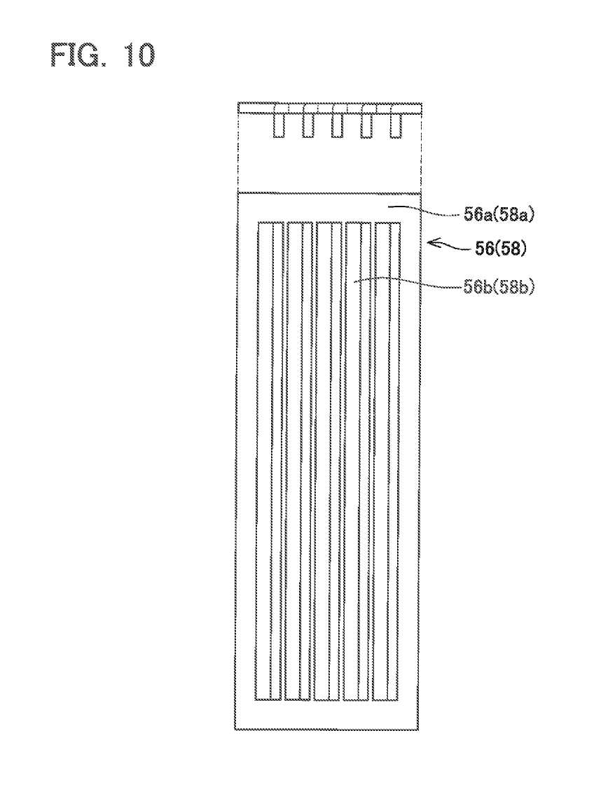

The frame electrode part 56a is connected to both ends (i.e., the upper and lower ends in FIG. 10) of the plurality of vertical electrode parts 56b. Due to this, the plurality of vertical electrode parts 56b is electrically connected to the frame electrode part 56a. The plurality of vertical electrode parts 56b is parallel to each other, and each extends in the up-down direction. The liquid level sensor 50 is disposed so that the vertical electrode parts 56b are located perpendicularly in a state where the upper surface of the fuel within the fuel tank is horizontal. The plurality of vertical electrode parts 56b is disposed at an equal interval in the up-down direction. The plurality of vertical electrode: parts 56b has the same length. As shown in FIG. 9, the vertical electrode parts 56b are curved toward the reference electrode 58 when seen in a cross-section vertical to the up-down direction.

The reference electrode 58 is disposed to face the signal electrode 56. The reference electrode 58 is grounded. The reference electrode 58 includes a frame electrode part 58a (see FIG. 10) and a plurality of (in FIG. 8, five) vertical electrode parts 58b. The reference electrode 58 has the same shape as the signal electrode 56. In the liquid level sensor 50, the reference electrode 58 is disposed to be vertically reversed in relation to the signal electrode 56. The frame electrode part 58a corresponds to the frame electrode part 56a, and the plurality of vertical electrode parts 58b corresponds to the plurality of vertical electrode parts 56b.

The signal electrode 56 and the reference electrode 58 are formed by pressing a flat plate made from metal (for example, SUS). Since the signal electrode 56 and the reference electrode 58 have the same shape, it is not necessary to manufacture the signal electrode 56 and the reference electrode 58 separately.

The signal electrode 56 and the reference electrode 58 are disposed at an interval. The openings 54 disposed between the vertical electrode parts 56b and 58b penetrate the frame 52. Between the vertical electrode parts 56b and 58b, the openings 54 extend in parallel along the vertical electrode parts 56b and 58b.

In the liquid level sensor 50, similarly to the liquid level sensor 10 and the like, it is possible to suppress adhering of the fuel. As a result, it is possible to suppress the capacitance of the liquid level sensor 50 from becoming a value that is not associated with the actual liquid level due to the adhering fuel.

In addition, the vertical electrode part 56b is curved toward the reference electrode 58, and the vertical electrode part 58b is curved toward the signal electrode 56. Thus, it is possible to increase the area of the portion in which the vertical electrode parts 56b and 58b face each other. As a result, it is possible to increase the capacitance of the liquid level sensor 50.

### Sixth Embodiment

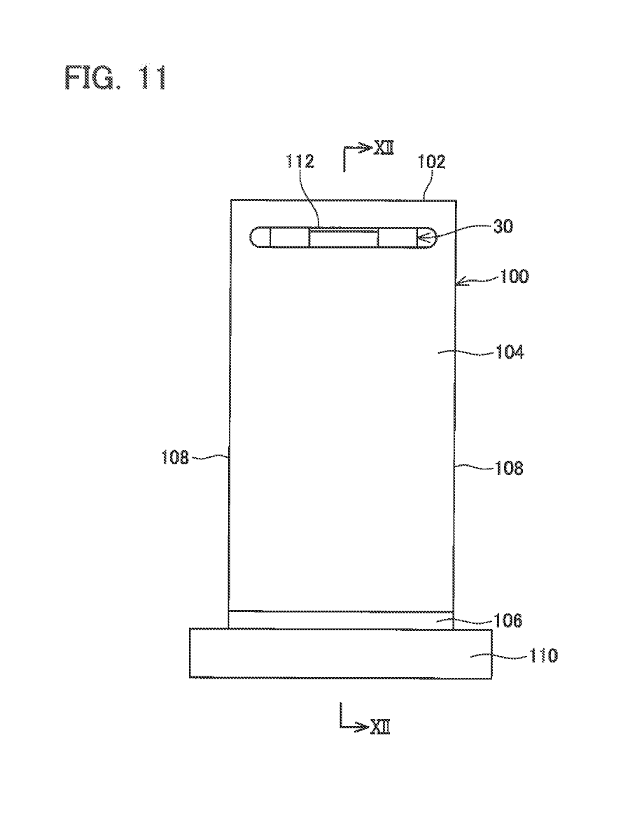

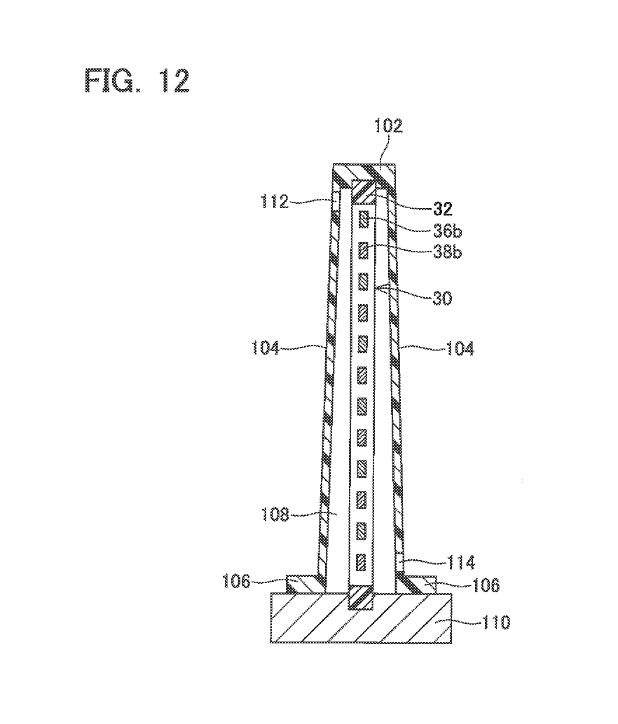

As shown in FIG. 11, since the present embodiment has the same configuration as the third embodiment except for a resin cover 100 and a pedestal 110, the description thereof will not be provided. Ends of the electrodes 36 and 38 of the liquid level sensor 30 are cut. The pedestal 110 is fixed to the lower end of the frame 32. The pedestal 110 has a cylindrical shape. The pedestal 110 may have a solid shape such as a solid rectangular parallelepiped shape other than the cylindrical shape. The pedestal 110 is fitted to a hole formed in a bottom surface of the fuel tank. Due to this, the frame 32 is supported so as not to be misaligned with the fuel tank. The resin cover 100 is fixed to the upper surface of the pedestal 110. The resin cover 100 covers the frame 32 and the electrodes 36 and 38. That is, the liquid level sensor 30 is stored in the space formed by the resin cover 100 and the pedestal 110. The upper ends of the electrodes 36 and 38 may protrude from the upper end of the resin cover 100. The resin cover 100 is fixed to the upper end of the frame 32. The resin cover 100 includes an upper wall 102, two side walls 104, two side walls 108, and two flanges 106. The upper wall 102 is fixed to the upper end of the frame 32. As shown in FIG. 12, the two side walls 104 extend from the upper wall 102 so as to be inclined in a vertically downward direction.

A ventilation hole 112 is formed in an upper end of one side wall 104 (i.e., the left side wall 104 in FIG. 12). The ventilation hole 112 passes through the side wall 104. The ventilation hole 112 is formed in a direction vertical to the up-down direction. The ventilation hole 112 is an inlet of air to the space formed by the resin cover 100 and the pedestal 110. A fuel passage 114 is formed in the lower end of the other side wall 104 (the right side wall 104 in FIG. 12). The fuel passage 114 passes through the side wall 104. The fuel passage 114 is formed in a direction vertical to the up-down direction. The fuel passage 114 is an inlet of fuel to the space formed by the resin cover 100 and the pedestal 110. Due to the ventilation hole 112 and the fuel passage 114, the liquid levels of the fuel inside and outside the space formed by the resin cover 100 and the pedestal 110 can be made identical to each other.

The two side walls 108 extend from the upper wall 102 in a vertically downward direction. The two side walls 104 and the two side walls 108 extend from the upper end of the frame 32 up to positions located lower than the lower ends of the electrodes 36 and 38. The flange 106 on each of the two side walls 104 protrudes from the lower end of the side wall 104 in a direction away from the frame 32.

The present embodiment can provide the same advantages as the third embodiment. Moreover, the resin cover 100 that covers the frame 32 and the like can suppress a liquid film from being formed on the electrodes 36 and 38.

The liquid sensor disclosed in the present description may be used in a liquid quality sensor or the like that specifies density of a specific component that constitutes a liquid in order to specify a physical quantity of a liquid using the capacitance between electrodes in addition to the liquid level sensor. Specifically, the liquid sensor (i.e., the sensor system 2) may be used for specifying a liquid level of a liquid within an oil pan or the like.

In addition, in the first embodiment, although one through-hole 14 is formed between one set of adjacent horizontal electrode parts 16b and 18b, a plurality of through-holes 14 may be formed between one set of adjacent horizontal electrode parts 16b and 18b. The same can be applied to the other embodiments.

In the respective embodiments, the liquid level sensor may include a protective film that covers the electrodes of the liquid level sensor. In this case, the protective film may be directly coated on the electrodes. Moreover, in the first embodiment, the protective film 13 may be formed on the surfaces of the electrodes 16 and 18 only and may be formed on both surfaces of the substrate 12.

1. A liquid sensor disposed within a reservoir storing a liquid, the liquid sensor comprising:
a base; and
a first electrode and a second electrode supported by the base, wherein
the first electrode comprises:
a plurality of first electrode parts disposed at an interval in a first direction and extending along a second direction being different from the first direction; and
a second electrode part electrically connecting the plurality of first electrode parts,
the second electrode comprises:
a plurality of third electrode parts extending along the second direction, the plurality of first electrode parts and the plurality of third electrode parts being disposed alternately in the first direction; and
a fourth electrode part electrically connecting the plurality of third electrode parts, and
an opening configured capable of passing the liquid through is disposed between adjacent first electrode part and third electrode part.

2. The liquid sensor according to claim 1, wherein
the opening extends along the second direction.

3. The liquid sensor according to claim 2, wherein
the second direction is a horizontal direction in a state where the liquid sensor is disposed within the reservoir.

4. The liquid sensor according to claim 2, wherein
the second direction is a direction that is inclined with respect to a horizontal direction in a state where the liquid sensor is disposed within the reservoir.

5. The liquid sensor according to claim 2, wherein
the second direction is a vertical direction in a state where the liquid sensor is disposed within the reservoir.

6. The liquid sensor according to claim 1, wherein
the base comprises a thin film-shaped substrate,
the first and second electrodes are disposed on a front surface of the substrate, and
the opening is an opening that penetrates the substrate disposed between the adjacent first electrode part and third electrode part from the front surface of the substrate to a rear surface of the substrate.

7. The liquid sensor according to claim 1, wherein
the base comprises a frame formed of resin, and
the first electrode and the second electrode are formed of a metal plate supported by the base.

8. The liquid sensor according to claim 1, further comprising:
a liquid-repellent protective film that covers the first electrode and the second electrode.
